(19) United States
(12) Patent Application Publication
(10) Pub. No.: US 2020/0048946 A1
(43) Pub. Date: Feb. 13, 2020

(54) GUIDE SYSTEM FOR GUIDING A FURNITURE DOOR

(71) Applicant: Julius Blum GmbH, Hoechst (AT)

(72) Inventors: Lukas BLUM, Bregenz (AT); Ingo GASSER, Hoechst (AT); Matthias RUPP, Hohenweiler (AT)

(21) Appl. No.: 16/656,086

(22) Filed: Oct. 17, 2019

Related U.S. Application Data
(63) Continuation of application No. PCT/AT2018/000040, filed on May 4, 2018.

(30) Foreign Application Priority Data
May 11, 2017 (AT) A 50394/2017

(51) Int. Cl. E05D 15/06; E05D 15/26; A47B 61/00; A47B 77/08

(52) U.S. Cl. CPC E05D 15/0652; E05D 15/26; A47B 61/00; E05Y 2900/212; E05D 15/266; E05Y 2201/684; A47B 77/08

(57) ABSTRACT

A guide system for guiding a furniture door, in particular a folding door or folding-sliding door, relative to a fixed furniture part includes a first guide rail and a running carriage which can be connected to the furniture door and which has a rolling body via which the running carriage is movably mounted on the first guide rail. The first guide rail has a running surface for the rolling body of the running carriage, and the first guide rail is assembled in the longitudinal direction from a first rail piece and one second rail piece. The two rail pieces can be releasably connected via a connecting piece on which there is formed a portion of the running surface for the rolling body of the running carriage.

### BACKGROUND OF THE INVENTION

The present invention concerns a guide system for guiding a furniture door, in particular a folding door or a folding-sliding door, relative to a stationary furniture part, and an article of furniture having at least one such guide system.

Guide systems for guiding a furniture door relative to a stationary furniture part are already known, wherein those guide systems in dependence on the respective dimensions of the article of furniture and the furniture doors to be guided have a guide rail of corresponding length.

That means, however, that transport is made more difficult as if many different guide rails have to be transported for different articles of furniture and furniture doors. In addition the assembly procedure is also made difficult as the person carrying out the assembly operation has to fit possibly very long guide rails to the article of furniture. In addition such guide systems are highly inflexible as it is necessary to provide respective guide rails that correspond to the respective dimensions of the articles of furniture and the furniture doors.

Considering that system, the guide rail of the guide system could also be cut into pieces. When the pieces of the guide rail are re-assembled then when the carriage runs along the assembled guide rail, it causes audible noise, this additionally resulting in bumpy unsettled rolling movement of the carriage.

### SUMMARY OF THE INVENTION

The object of the invention is to avoid at least one of the above-described disadvantages and to provide a guide system which is improved over the state of the art and an improved article of furniture.

An essential idea in regard to the guide system according to the invention is therefore that the at least one first guide rail is composed in the longitudinal direction of at least a first rail portion and a second rail portion, wherein the two rail portions can be releasably connected by way of at least one connecting portion at which there is provided a portion of the at least one running surface for the at least one rolling body of the at least one running carriage. That ensures a smoother travel of the carriage along the at least one running surface.

So that the connection between the individual rail portions is improved and audible noise can be substantially avoided it can be provided that the rail portions of the at least one first guide rail can be positioned relative to each other with the at least one connecting portion by way of at least one respective positioning device, preferably wherein the at least one positioning device has at least one wedge and at least one corresponding counterpart shape.

By virtue of the at least one positioning device it is possible for the transition between the rail portions to be substantially stepless and only tolerances of the material play a part. The connection itself does not involve any additional differences in level between the rail portions.

As mentioned in the opening part of this specification protection is also claimed for an article of furniture having at least one furniture door, in particular a folding door or folding-sliding door, at least one stationary furniture part and at least one guide system for guiding the at least one furniture door relative to the at least one stationary furniture part.

### BRIEF DESCRIPTION OF THE DRAWINGS

Further advantages and details of the invention will be apparent from the Figures and the accompanying specific description. In the Figures:

FIGS. 1a-1c show perspective views of an article of furniture with two furniture doors shown in different positions,

FIG. 2 shows a guide system and a folding-sliding door as a perspective view,

FIGS. 3a-3b show the carriage as a perspective view, a plan view and a detail of the plan view,

FIG. 4 shows a perspective view of a first embodiment of the first guide rail which has been cut into pieces,

FIG. 5 shows a perspective view of the first guide rail which has been cut into pieces,

FIG. 6 shows a perspective view and a detail thereof illustrating a rail portion of the first guide rail,

FIG. 7 shows a perspective view and a detail thereof illustrating a rail portion of the first guide rail and the adaptor portion,

FIG. 8 shows a perspective sectional view and a detail thereof showing the rail portion of the first guide rail,

FIG. 9 shows a perspective view of two adaptor portions and the connecting portion,

FIGS. 10a-10b show a perspective view and a sectional view thereof showing two adaptor portions and the connecting portion partially connected to the adaptor portions,

FIGS. 11a-11b show a perspective view and a sectional view thereof showing two adaptor portions and the connecting portion connected to the adaptor portions,

FIGS. 12a-12b show a perspective view and a plan view of a section of FIG. 11a,

FIG. 13 shows a further sectional view of FIG. 11a with the rail portions, and

FIGS. 14a-14b show perspective views of a further embodiment of a first guide rail which has been cut into pieces.

### DETAILED DESCRIPTION OF THE INVENTION

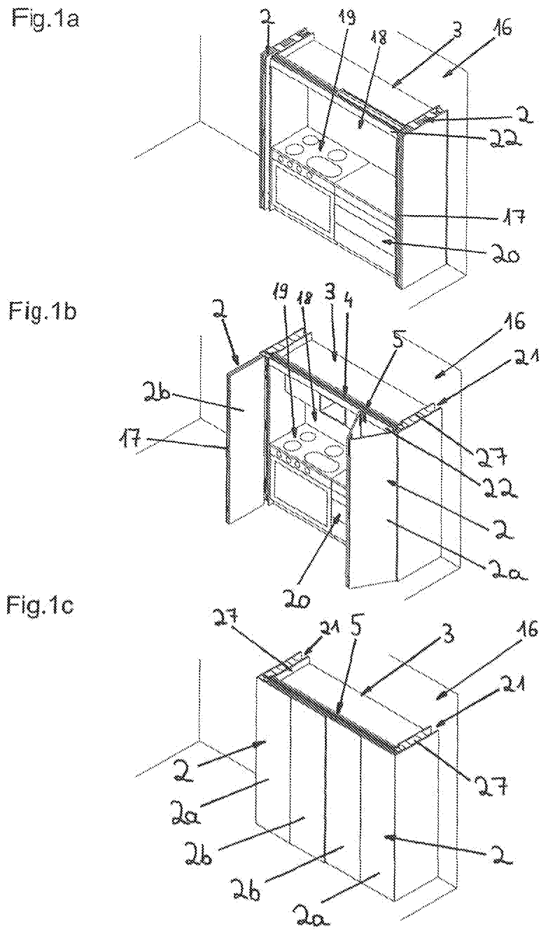

FIGS. 1a, 1b and 1c show an article of furniture 16 having a stationary furniture part 2, two furniture walls 27 and two furniture doors 2. Those furniture doors 2 are in the form of folding-sliding doors and each comprise a first door leaf 2a and a second door leaf 2b, wherein the two door leaves 2a, 2b are foldable by way of the folding door hinges 17. The article of furniture 16 further has a receiving region 18 and two laterally arranged receiving compartments 21 or “pockets”. It is therefore provided that the article of furniture 16 has a receiving region 18 for receiving components of a kitchen 19 (for example electric appliances like cooker, oven and so forth), a clothes storage arrangement 20 (for example drawers, coat hangers, boxes etc) or the like.

A respective furniture door 2 is retractable in the two receiving pockets 21 which can be arranged laterally in or on the article of furniture 16. The receiving pockets 21 can therefore be arranged either from the exterior on the article of furniture 16 or however the receiving pockets 21 are in the article of furniture 16, for example by the arrangement of an additional wall.

In that respect the view shown in FIG. 1a corresponds to the parked position of the furniture doors 2 and that shown in FIG. 1c corresponds to the closed position of the furniture doors 2. The second door leaf 2b is respectively coupled to a running carriage 5, the carriage 5 being displaceable along a first guide rail 4. Arranged in the receiving pockets 21 or more precisely at the furniture walls 27 are further guide rails 14 (not visible) for guiding the furniture doors 2. In that arrangement the two receiving pockets 21 are of an internal width of 10 to 30 cm and/or a height of 100 to 250 cm and/or a depth of 60 to 100 cm. The first guide rail 4 is therefore arranged substantially transversely relative to the further guide rails 14 on the article of furniture 16.

In addition there is provided a bar 22 which is either part of the first guide rail 4 or is in the form of a component separate therefrom. The movement of the furniture doors 2 between the parked position and the closed position is therefore made possible by the first guide rail 4 and the further guide rails 14. Starting from the parked position of the furniture doors 2, in which the door leaves 2a, 2b are oriented substantially parallel to each other, the furniture doors 2 can therefore be moved into that position in FIG. 1b, which is visible by virtue of the furniture door 2 shown at the left. In that case the furniture doors 2 are displaced along the further guide rails 14. Subsequently the furniture doors 2 are moved into the substantially coplanar position as shown in FIG. 1c. For that purpose the respective door leaf 2b is displaced by means of the carriage 5 along the first guide rail 4 until reaching the dosed position of the furniture doors 2, in which the two door leaves 2a, 2b are oriented in substantially coplanar relationship. For moving the furniture doors 2 from their closed position into their parked position the same procedure is carried out in the reverse sequence.

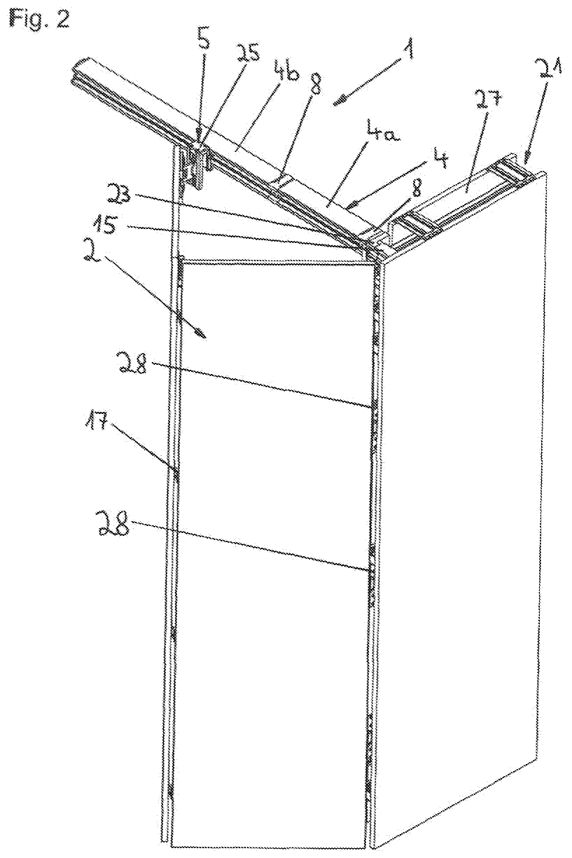

FIG. 2 shows the guide system 1 which includes the first guide rail 4 and the carriage 5. In this case the first guide rail 4 comprises the two rail portions 4a, 4b, those two rail portions 4a, 4b being connected together by way of the connecting portion 8. In addition there is provided a transfer device 23 connected to the first rail portion 4a of the first guide rail 4 by way of the connecting portion 8. At its underside the transfer device 23 has a control cam so that the kinetic energy of the furniture door 2 can be utilised in the transition from the first guide rail 4 on to the further guide rail 14 or from the further guide rail 14 on to the first guide rail 4. In the illustrated view the carrier 15 adjoins that transfer device 23. In addition a respective vertical carrier structure 34 is mounted moveably at the further guide rails 14, wherein hinges 28 are arranged on that carrier structure 34 for fixing the first door leaf 2a of the furniture door 2 so that the furniture door 2 can be retracted into the receiving pockets 21. When the furniture door 2 is moved into that position in which the door leaves 2a, 2b are oriented in substantially mutually parallel relationship then the carriage 5 is displaced on to the carrier 15. The carrier 15 is further arranged on the vertical carrier structure 34 and thus the furniture door 2 can be displaced along the further guide rail 14. There are therefore provided at least one further guide rail 14 and at least one carrier 15, wherein the at least one carrier 15 is mounted displaceably at the at least one further guide rail 14, the at least one carriage 5 can be arranged on or at the at least one carrier 15 and the at least one carrier 15 can be arranged at least region-wise in the prolongation in relation to the first guide rail 4.

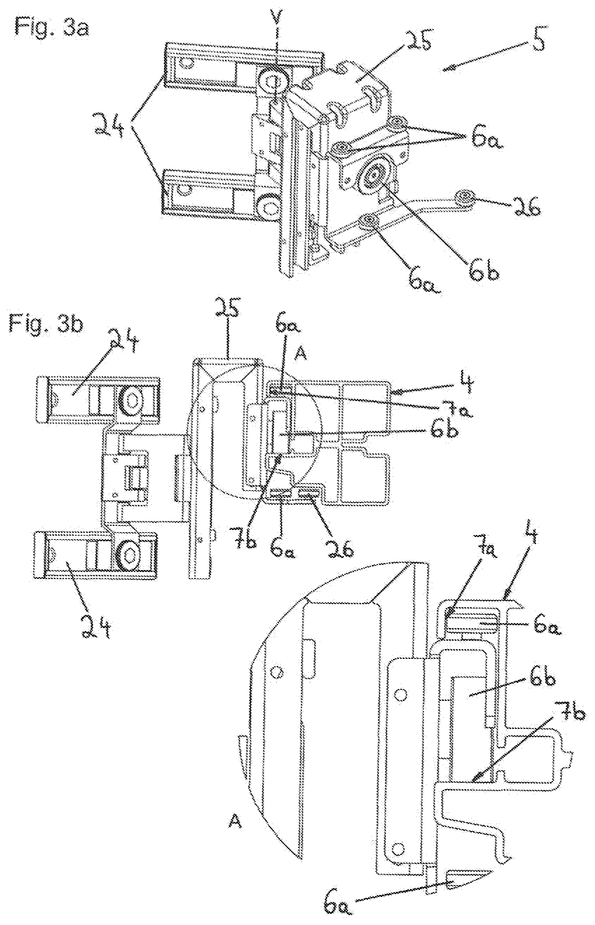

FIG. 3a shows a perspective view of the carriage 5. The carriage 5 has a carrier profile member 25 and the fitments 24 hingedly connected to the carrier profile member 25 about the vertical axis V. Those fitments 24 serve for fixing the door leaves 2b. In addition the rolling bodies 6a and 6b and the control roller 26 are arranged on the carrier profile member 25. In that case the rolling bodies 6a and the control roller 26 are mounted rotatably about a vertical axis and the rolling body 6b is mounted rotatably about a horizontal axis (that rotatable mounting configuration relates to the assembled position of the carriage 5). FIG. 3b shows the carriage 5 mounted moveably along the first guide rail 4 as a plan view and a detail view of the region A. It can be seen in that respect that the carrier profile member 25 is of a substantially U-shaped configuration so that the carrier profile member 25 can be fitted on to the bar 22 and is also displaceable along the bar 22. The first guide rail 4 has the two running surfaces 7a, 7b, wherein the two upper rolling bodies 6a are supported at the running surface 7a and are displaceable along same. In contrast the rolling body 6b is supported at the running surface 7b and is displaceable along same. Accordingly the rolling bodies 6a serve to carry horizontal forces and the rolling body 6b serves to carry vertical forces (for example the force due to the weight of the furniture door 2 which can be arranged on the carriage 5 by way of the fitments 24).

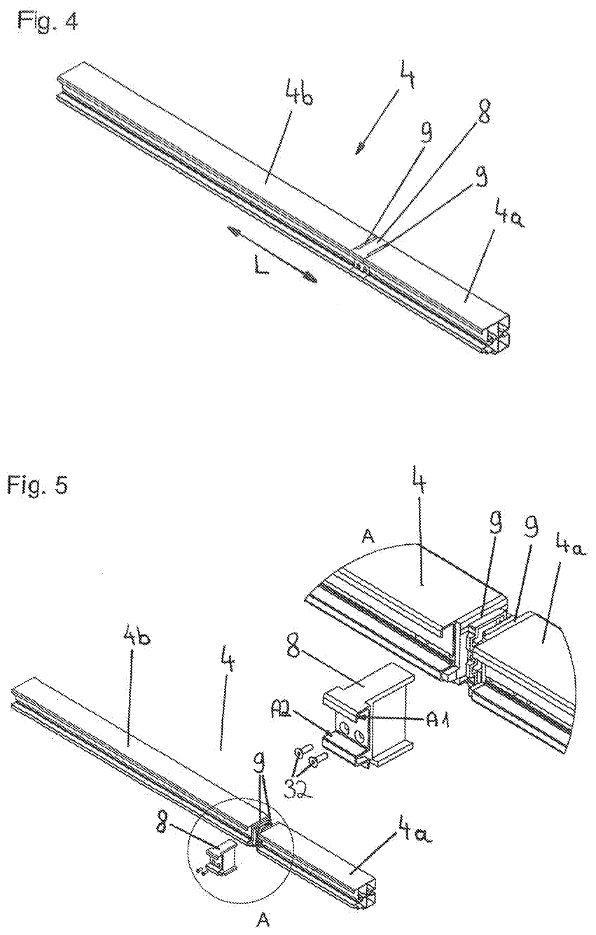

FIG. 4 shows a first embodiment of the first guide rail 4 which has been cut into pieces in the longitudinal direction L. That first guide rail 4 has the first rail portion 4a and the second rail portion 4b. In this view the two rail portions 4a, 4b are already connected together. In that respect it can be provided that at least one of the rail portions 4a, 4b of the at least one first guide rail 4 can be adapted in respect of its length, with connectability to further rail portions 4a, 4b being retained.

FIG. 5 shows the first guide rail 4 comprising the two rail portions 4a, 4b. in a perspective view and a detail view of the region A. Here it is possible to see the two adaptor portions 9 which are fitted into the two rail portions 4a, 4b. The rail portions 4a, 4b of the at least one first guide rail 4 are in this case in the form of a hollow chamber profile member, preferably wherein possibly provided adaptor portions 9 can be at least region-wise received in end parts of the rail portions 4a, 4b. The connecting portion 8 can be inserted between those two adaptor portions 9 and then the two screws 32 are screwed into the respective holes in the connecting portion 8 and the adaptor portions 9 so that the connecting portion 8 is screwed to the two adaptor portions 9 and at the same time a connection is made between the two rail portions 4a, 4b. It is therefore provided that the rail portions 4a, 4b of the at least one first guide rail 4 respectively have at least one adaptor portion 9, by way of which the rail portions 4a, 4b can be releasably connected to the at least one connecting portion 8, preferably by way of a screw and/or clamping connection.

It is noted at this juncture that the adaptor portions 9 can also be in one piece with the respective rail portion 4a, 4b. In this connection it is also noted that the respective at least one adaptor portion 9 in the assembled state (see FIG. 4) is substantially concealed relative to the exterior by the respective rail portion 4a, 4b and the at least one connecting portion 8. In addition provided on the connecting portion 8 is the portion A1 of the running surface 7a for the rolling bodies 6a of the carriage 5 and the portion A2 of the running surface 7b for the rolling body 6b of the carriage 5.

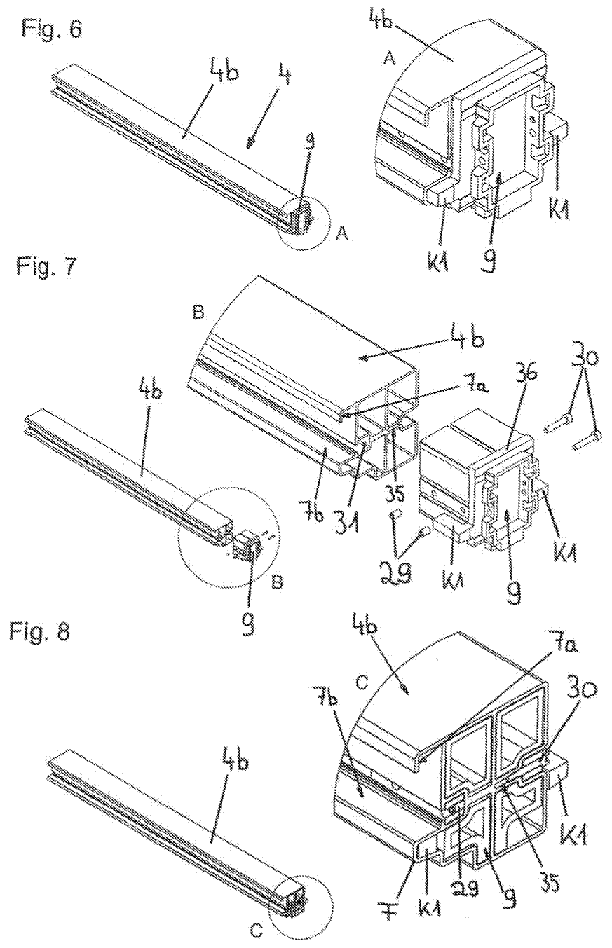

FIG. 6 shows a perspective view and a detail view of the region A illustrating the second rail portion 4b and the adaptor portion 9 received in the second rail portion 4b. In this case it is possible to see the two wedges K1 of the adaptor portion 9.

FIG. 7 shows a perspective view and a detail view of the region B illustrating the second rail portion 4b and the adaptor portion 9. This view serves to explain the connection between the second rail portion 4b and the adaptor portion 9. At both sides at which the wedges K1 are provided the adaptor portion 9 respectively comprises two holes for receiving screws. After the adaptor portion 9 has been fitted into the rail portion 4b the grub screws 29 which have a male thread and the self-tapping screws 30 can be screwed into the respective holes. It is therefore provided that the adaptor portion 9 can be releasably connected to the respective rail portion 4a, 4b, preferably by way of a screw and/or clamping connection. Alternatively it would also be possible for the adaptor portions 9 to be glued into the respective rail portions 4a, 4b. When the grub screws 29 are sufficiently deeply screwed in, they meet the surface 31 so that when the grub screws 29 are further screwed in the adaptor portion 9 is moved in the direction of the running surfaces 7a, 7b. A similar consideration applies to the self-tapping screws 30 as the self-tapping screws 30 on being screwed in are screwed into the elongate slot 35 in the rail portion 4b and thus push the adaptor portion 9 in the direction of the running surfaces 7a, 7b. It can therefore be provided that the respective at least one adaptor portion 9 upon releasable connection to the respective rail portion 4a, 4b is moveable in the direction of the at least one running surface 7a, 7b for the at least one rolling body 6a, 6b of the at least one carriage 5. It will be appreciated that the nature of the screws referred to in this respect should not be interpreted as being restrictive. Other types of screws can also be used.

FIG. 8 shows the adaptor portion 9 received in the second rail portion 4b in a sectional view through the first screw plane and a detail view of the region C. The adaptor portion 9 has been moved in the direction of the running surfaces 7a, 7b by the screwed-in grub screws 29 and self-tapping screws 30, in which case the wedge K1 shown at the left has also been pressed into the shape F of the rail portion 4b, that corresponds to the wedge K1. Accordingly, the adaptor portion 9 is positioned both in respect of depth and also height relative to the rail portion 4b by the wedge K1, the shape F of the rail portion 4b, that corresponds to the wedge K1, the grub screws 29 and the self-tapping screws 30. Positioning in the longitudinal direction L of the rail portion 4b can be effected by the projecting bar 36 of the adaptor portion 9 (see FIG. 7).

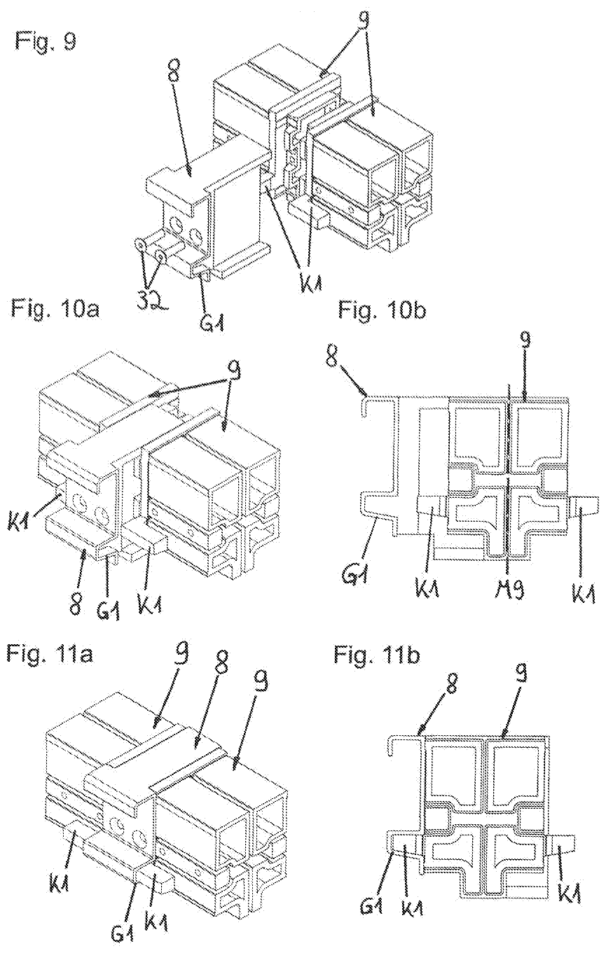

FIG. 9 shows a perspective view of two adaptor portions 9 and the connecting portion 8. The connecting portion 8, like the rail portion 4b, has a counterpart shape G1 corresponding to the wedge K1.

FIG. 10a shows a development of FIG. 9, wherein the connecting portion 8 has been partially inserted between the adaptor portions 9. FIG. 10b shows a sectional view of FIG. 10a. In this case the central plane M9 of the adaptor portion 9 is visible. It is therefore provided that the respective at least one adaptor portion 9 is of a mirror-image symmetrical configuration relative to the central plane M9. The wedge K1 shown at the right is not necessary in this view for making the connection, but the adaptor portions 9 can be used universally for both ends of a rail portion 4a, 4b.

FIG. 11a in turn shows a development of FIG. 10a, wherein the connecting portion 10 has been inserted completely between the two adaptor portions 9. FIG. 11b shows a sectional view of FIG. 11a. In this view the screws 32 can then be screwed into the corresponding holes in the connecting portion 8 and the adaptor portions 9 so that the connecting portion 8 is fixedly connected to the adaptor portions 9. In that way the wedge K1 shown at the left of the adaptor portion 9 is moved into the counterpart shape G1 of the connecting portion 8 so that the connecting portion 8 is adjusted in respect of height and depth.

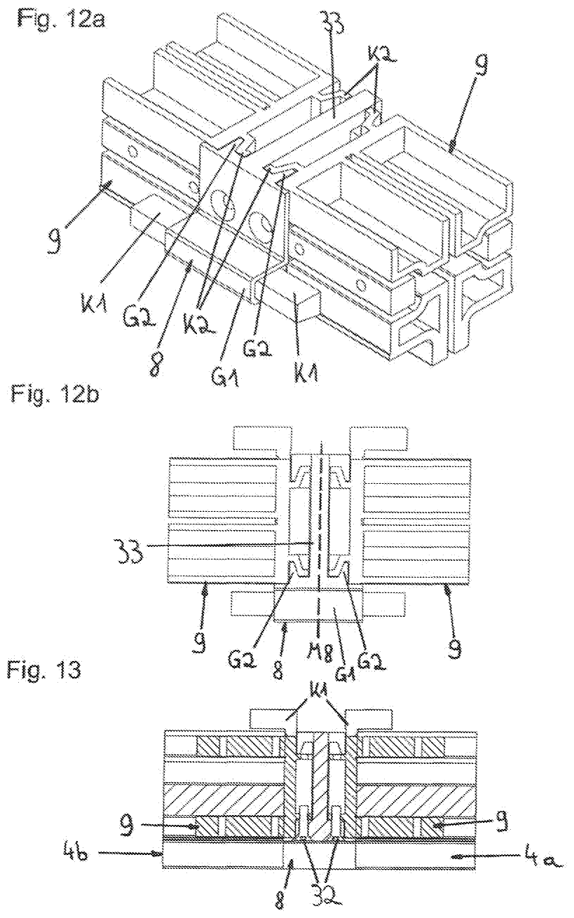

FIG. 12a shows the view in FIG. 11a, with the upper part of FIG. 11a being cut away. In that respect it can be seen that the adaptor portions 9 have further wedges K1 which, when the adaptor portions 9 are connected to the connecting portion 8 cooperate with further counterpart shapes G2 of the connecting portion 8. In addition the connecting portion 8 has a central bar 33 so that the adaptor portions 9 do not bear against each other upon being connected by way of the connecting portion 8.

FIG. 12b shows a plan view of FIG. 12a. In this case the central plane M8 of the connecting portion 8 is also shown. It is therefore provided that the at least one connecting portion 8 is of a mirror-image symmetrical configuration relative to the central plane M8. When the screws 32 are screwed into the respective holes in the connecting portion 8 and the adaptor portions 9 the counterpart shapes G1 are pressed against the wedges K2 so that the adaptor portions 9 are moved relative to each other. It is therefore provided that the rail portions 4a, 4b of the at least one first guide rail 4 can be positioned relative to each other with the at least one connecting portion 8, by way of at least one positioning device K1, K2, G1, G2, preferably wherein the at least one respective positioning device has at least one wedge K1, K2 and at least one corresponding counterpart shape G1, G2.

FIG. 13 shows a sectional view of FIG. 12b through the plane of the screws 32, the rail portions 4a, 4b additionally being shown. In addition the screws 32 are screwed into the connecting portion 8 and the adaptor portions 9, wherein those screws 32 have a male thread cooperating with a female thread of the respective holes in the adaptor portions 9. The grub screws 29 which are screwed like the screws 32 into the lower holes in the view and the self-tapping screws 30 which are screwed into the upper holes in the view are not shown. The positioning device K1, K2, G1, G2 therefore serves on the one hand for positioning the connecting portions 8 relative to the adaptor portions 9 and the rail portions 4a, 4b respectively and on the other hand for positioning the adaptor portions 9 relative to the rail portions 4a, 4b. After the respective positioning operation has been carried out the running surfaces 7a, 7b have been completed by the portions A1, A2 of the connecting portion 8. Accordingly the carriage 5 runs only over the running surfaces 7a, 7b provided on the rail portions 4a, 4b and over the portions A1, A2 of the running surfaces 7a, 7b of the connecting portion 8. In other words, when the carriage 5 runs along the first guide rail 4, the individual rolling bodies 6a, 6b do not come directly into contact with the adaptor portions 9.

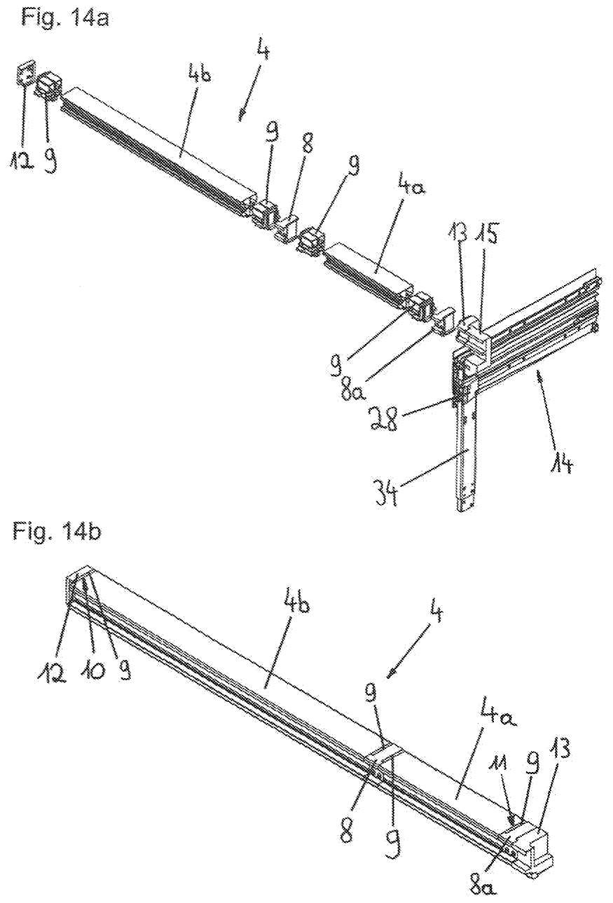

FIGS. 14a and 14b show a further embodiment of the first guide rail 4. In this case it is possible to see the further guide rail 14 which is arranged substantially transversely relative to the first guide rail 4. The vertical carrier structure 34 and the carrier 15 arranged thereon are mounted displaceably on that further guide rail 14. In addition a hinge 28 is arranged at the carrier structure 34, serving for fixing the first door leaf 2a. In this arrangement disposed at the two ends 10, 11 of the first guide rail 4 are the two termination portions 12, 13, the termination portion 13 additionally performing the function of the transfer device 23 shown in FIG. 2. That termination portion 13 is connected by way of the further connecting portion 8a to the first rail portion 4a of the first guide rail 4.

It can therefore be provided that the at least one first guide rail 4 has a termination portion 12, 13 at one or at both ends 10, 11. It can further be provided that at least one of the termination portions 13 can be releasably connected to the at least one first guide rail 4, preferably by way of at least one further connecting portion 8a which is identical to the at least one connecting portion 8, by way of which the two rail portions 4a, 4b of the at least one first guide rail 4 can be releasably connected.

In the case of a guide system 1 it can also be provided that all component parts from which the guide system 1 is made up are of a maximum length of 1200 mm and a maximum width of 800 mm so that they can be arranged on an Europool pallet for dispatch purposes.

### LIST OF REFERENCES

1 guide system
2 furniture door
2a first door leaf
2b second door leaf
3 stationary furniture part
4 first guide rail
4a first rail portion
4b second rail portion
5 running carriage
6a, 6b rolling body
7a, 7b running surface
8 connecting portion
8a further connecting portion
9 adaptor portion
10, 11 ends of the first guide rail
12, 13 termination portion
14 further guide rail
15 carrier
16 article of furniture
17 folding door hinge
18 receiving region
19 component parts of a kitchen
20 clothes storage arrangement
21 receiving pocket
22 bar
23 transfer device
24 fitment
25 carrier profile member
26 control roller
27 furniture wall
28 hinges
29 grub screws
30 self-tapping screws
31 surface
32 screws
33 central bar
34 vertical carrier structure
35 elongate slot
36 projecting bar
A1 portion of the running surface 7a
A2 portion of the running surface 7b
L longitudinal direction
K1 wedge
K2 wedge
G1 counterpart shape
G2 counterpart shape
M8 central plane
MK9 central plane
V vertical axis
F shape of the rail portions corresponding to the wedge K1

1. A guide system for guiding a furniture door, in particular a folding door or a folding-sliding door, relative to a stationary furniture part, comprising at least one first guide rail and at least one running carriage which can be connected to the furniture door and which has at least one rolling body, by way of which the at least one running carriage is mounted moveably on the at least one first guide rail, wherein the at least one first guide rail as at least one running surface for the at least one rolling body of the at least one running carriage, wherein the at least one first guide rail is composed in the longitudinal direction of at least a first rail portion and a second rail portion, wherein the two rail portions can be releasably connected by way of at least one connecting portion at which there is provided a portion of the at least one running surface for the at least one rolling body of the at least one running carriage.

2. The guide system according to claim 1, wherein the rail portions of the at least one first guide rail can be positioned relative to each other with the at least one connecting portion by way of at least one respective positioning device, preferably wherein the at least one positioning device has at least one wedge and at least one corresponding counterpart shape.

3. The guide system according to claim 1, wherein the at least one connecting portion is of a mirror-image symmetrical relationship relative to a central plane.

4. The guide system according to claim 1, wherein the rail portions of the at least one first guide rail each have at least one adaptor portion, by way of which the rail portions can be releasably connected to the at least one connecting portion, preferably by way of a screw and/or clamping connection.

5. The guide system according to claim 4, wherein the respective at least one adaptor portion is of a mirror-image symmetrical configuration relative to a central plane.

6. The guide system according to claim 4, wherein the respective at least one adaptor portion can be releasably connected to the respective rail portion, preferably by way of a screw and/or clamping connection.

7. The guide system according to claim 6, wherein the respective at least one adaptor portion in the releasable connection to the respective rail portion is moveable in the direction of the at least one running surface for the at least one rolling body of the at least one running carriage.

8. The guide system according to claim 4, wherein the respective at least one adaptor portion in the assembled state is substantially concealed outwardly by the respective rail portion and the at least one connecting portion.

9. The guide system according to claim 1, wherein the rail portions of the at least one first guide rail are in the form of a hollow chamber profile member, preferably wherein possibly provided adaptor portions can be received at least region-wise in end parts of the rail portions.

10. The guide system according to claim 1, wherein at least one of the provided rail portions of the at least one first guide rail can be adapted in respect of its length, with connectability to further rail portions being retained.

11. The guide system according to claim 1, wherein all component parts from which the guide system can be composed are of a maximum length of 1200 mm and a maximum width of 800 mm so that they can be arranged for dispatch purposes on an Europool pallet.

12. The guide system according to claim 1, wherein the at least one first guide rail has a termination portion at one or at both ends.

13. The guide system according to claim 12, wherein at least one of the provided termination portions can be releasably connected to the at least one first guide rail, preferably by way of at least one further connecting portion which is identical to the at least one connecting portion, by way of which the two rail portions of the at least one first guide rail can be releasably connected.

14. The guide system according to claim 1, wherein there are provided at least one further guide rail and at least one carrier, wherein the at least one carrier is mounted moveably to the at least one further guide rail, the at least one running carriage can be arranged on or at the at least one carrier and the at least one carrier can be arranged at least region-wise in the prolongation in relation to the first guide rail.

15. An article of furniture having at least one furniture door, in particular a folding door or a folding-sliding door, at least one stationary furniture part and the guide system according to claim 1 for guiding the at least one furniture door relative to the at least one stationary furniture part.
